(19) United States
(12) Patent Application Publication
(10) Pub. No.: US 2008/0110085 A1
(43) Pub. Date: May 15, 2008

(54) Tree Support Device

(76) Inventor: Ron Merx, Erie, CO (US)

Correspondence Address: Leyendecker & Lemire, LLC, C/O PORTFOLIO IP, P.O. BOX 52050, MINNEAPOLIS, MN, 55402, US

(21) Appl. No.: 11/559,636

(22) Filed: Nov. 14, 2006

(51) Int. Cl. A01G 17/04

(52) U.S. Cl. 47/42

(57) ABSTRACT

An embodiment of a tree support device comprising a first strap and a second strap. The first strap of one embodiment having a first bore, a second bore, a proximal end, and a distal end. The second strap in one variation also having a proximal end and a distal end. In a variation, the second strap proximal end is coupled to the first strap distal with a grommet at the second bore. The longitudinal axis of the two straps may be generally parallel.

The first strap is adapted to wrap around the trunk of a newly planted tree. The distal end of the second strap is adapted to thread through the first strap bores and toutly couple to a device such as a stake substantially fixed to the ground.

### FIELD OF THE INVENTION

This invention generally relates to newly planted tree support systems.

### BACKGROUND

Planting trees, especially when developing the landscape surrounding a residence or commercial building, often involves the use of a tree support system. Tree support systems are designed to enable a planted tree to grow straight. A tree support system also keeps the tree from blowing over due to excessive wind and fosters proper root and trunk development. When the tree is substantially mature, the support system is removed from the tree.

Typical prior art tree support systems provide temporary lateral support by staking or otherwise coupling a cable, rope, or wire to the ground on one end and attaching the other end to a strap or other mechanism that is wrapped around the tree. In order for the wire stretching from the tree to the stake to be visible to persons walking near the tree (so they do not trip over or otherwise hit the wire), polyvinylchloride (“PVC”) piping is often placed around the wire.

The prior art tree stabilization systems described above are deficient in many aspects. The sheer number of components involved makes the system cumbersome and time consuming to set up. Requiring an employee to place support systems on a large number of trees requires the employee to carry around 4 separate components—(i) wire/cable, (ii) stakes, (iii) PVC piping, (iv) straps, and (v) tools. This may be potentially dangerous if the employee must manually transplant all these components from tree to tree as the weight of these components may be great when a large number of trees must be supported.

The PVC piping is particularly important in prior art systems. Since a thin wire is typically used to couple the tree to the ground, as stated, the PVC piping is required to make the wire visible to people. However, the PVC piping adds substantial cost to the support system. Lowering costs in the landscaping business in highly desirable, and eliminating one or more of these components would enable a landscaping business to substantially lower its operating costs.

Additionally, costs may be lowered by decreasing the amount time it takes to set up a tree stabilization system. Typical prior art stabilization systems may take as long as 30 minutes to set up. Even for persons experienced in landscaping, setting up a tree stabilization system comprised of these components typically take as long as 10 minutes. This is important when hourly billing rates can range from $12.00 an hour up to $65.00 an hour, depending on geographical region and level of experience.

Lastly, some prior art tree support systems use materials which, when in contact with the tree, damage the tree. For example, some wire support systems may scrape and damage the bark of a young and vulnerable tree. Such injuries make the tree susceptible to disease and disfiguration.

### SUMMARY OF THE DRAWINGS

FIG. 1 is a top view of a tree support device according to a first embodiment of the present invention.

FIG. 2 is an isometric view of a tree support device with a first strap in a looping position and the second strap threaded through the first strap bores according to one embodiment of the present invention.

FIG. 3 is a view of a tree support device first strap looped around a tree and second strap substantially fixed according to one embodiment of the present invention.

FIG. 4 is a view of a tree support device with a first strap in a looping position and the second strap threaded through the first strap bores and the slit according to a second embodiment of the present invention.

FIG. 5 is an isometric view of the first strap according to one embodiment of the present invention.

FIG. 6A is an isometric view of the second strap according to a first embodiment of the present invention.

FIG. 6B is an isometric view of the second strap according to a second embodiment of the present invention.

FIG. 7 illustrates one method of supporting a tree.

### DETAILED DESCRIPTION

One way to lower the costs associated with installing tree stabilization systems is to use a fewer number of materials than has been used on prior art stabilization systems. Additionally, if the materials themselves have a lower cost than materials used on prior art systems, the total cost of the stabilization system will continue to decrease. Importantly, one embodiment of the current invention incorporates both a lower number of total materials than prior art tree stabilization systems and materials that have a lower cost than prior art systems. Lastly, the materials used to contact the tree in the current invention are flexible and designed to prevent injuring the tree.

Overall, one embodiment is a lightweight system adapted to be used in a quick, efficient manner. Multiple support systems can simply be stuffed in a pocket, and easily looped around a tree and staked into the ground. The efficiency of installing tree support systems with one embodiment is greatly increased.

For example, one embodiment of the current invention is comprised of two straps. The straps are comprised of a flexible woven mesh material which may be a synthetic thermoplastic polymer such, but not limited to, nylon or polypropylene. The straps may also be comprised of a non-synthetic material such as, but not limited to, leather.

One embodiment's two straps are a first strap and a second strap, with each strap having a generally rectangular shape. The first strap is generally wider and shorter than the second strap in one variation. One embodiment's first strap is about 12 inches long and about 1.5 inches wide, with the second strap being about 4 feet long and about ¾ inches in width.

The first strap in one embodiment is comprised of a first bore and a second bore and the second strap is comprised of a second strap bore. The two straps are often coupled together with a grommet encircling the second bore and the second strap bore, with the longitudinal axis of the second bore being substantially aligned with the longitudinal axis of a second strap bore. The second bore is proximate the distal end of the first strap. The second strap bore is proximate the proximal end of the second strap.

Additionally, the two straps are coupled in a manner where the longitudinal axis of both straps are generally parallel. One embodiment may not have a second strap which is coupled to the first strap, but may have a second strap which is integrated to the first strap in manner where the longitudinal axis of the two straps are substantially parallel. The second strap also typically has a free end, the free end being an end distal from the proximal end of the second strap.

The first bore of the first strap of one embodiment is also grommeted. In one two-bore embodiment, each bore is positioned generally equal distances from a strap end. The first bore may be positioned a distance generally equal from the proximal end of the first strap that the second bore is positioned from the distal end of the first strap. Widthwisely, each bore is generally located in the center of the first strap. Therefore, when the first strap is looped around a tree sapling such that the first strap distal end is positioned proximate the first strap proximal end, the longitudinal axis of the bores are generally aligned.

Upon general alignment of the first strap bores after looping the first strap around the tree sapling, the second strap free end is adapted to thread through the first strap bores. In one variation, where the second strap proximal end is coupled to the first strap distal end, the second strap distal end is pulled through the bores until the second strap is substantially taut. Threading the second strap distal end through the first end bores creates a second strap loop around the first strap distal end and keeps the first strap bores substantially aligned. The second strap is pulled taut at this point and coupled to a stake which is typically placed into the ground, enabling the first strap to hold its loop shape around the tree and providing support the tree sapling.

In one variation, where the proximal end of the second strap is not coupled to the first strap, upon threading the distal end through the bores, the distal end is then threaded through a second strap slit and pulled taut. The second strap slit is located proximate the second strap proximal end. Again, the second strap tautness keeps the first strap against the tree trunk to provide the support necessary to keep the tree stable during high winds or otherwise. In one variation, the second strap is substantially fixed to the stake placed in the ground in order to keep the tautness present in the second strap.

### TERMINOLOGY

The terms and phrases as indicated in quotation marks (“”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “bore” refers to the interior of a hole, usually referring to the diameter of a generally circular hole.

The term “slit” refers to a generally straight and narrow cut, opening, or aperture.

### First Embodiment of a Tree Support Device

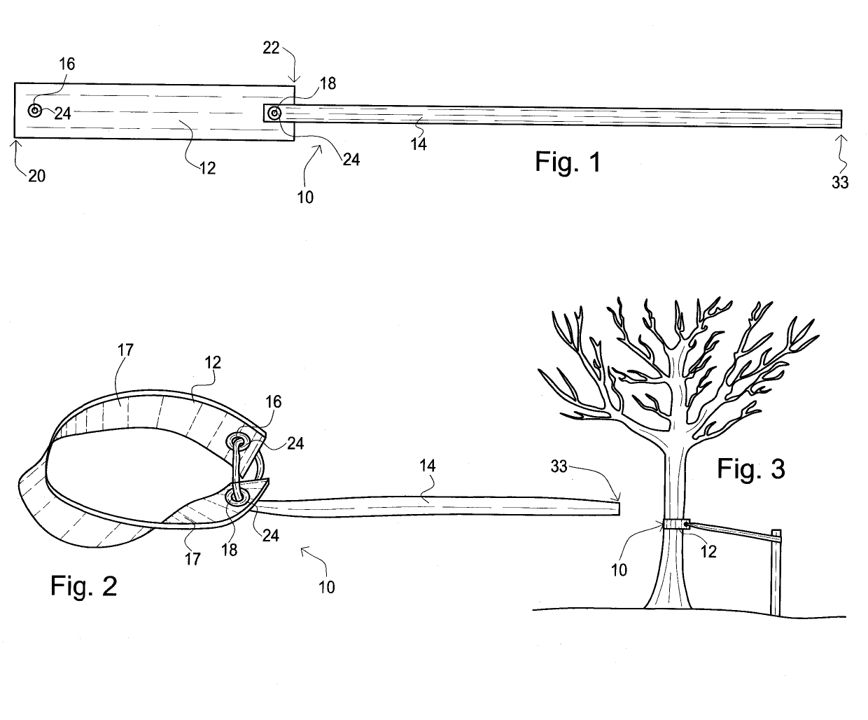

Referring to FIGS. 1, 2, 3, 5, and 6A, an embodiment of a tree support device 10 is illustrated. The variation is comprised of a first strap 12 and a second strap 14. The first strap is comprised of a flexible material, with the first strap capable of being formed from many different types of material. In one embodiment, the type of material used is a woven mesh material, such as, but not limited to, a polymeric webbing such as a synthetic nylon or polypropylene mesh. The first strap may be comprised of a non-mesh material as well. For example, the first strap may be comprised of leather or nonwoven polyethylene fabric, such as Tyvek®. With any material, the yield strength of the material should be high enough such that stresses imposed by high gusts of wind on the strap, or other environmental stresses or stresses typically involved with landscaping and tree planting do not plastically deform the material or cause it to break.

Whatever type of flexible material is used in the first strap 12, the material is also adapted to prevent injuries to the tree. Polymeric webbing may be inherently adapted to prevent damage to the tree if the surface of the webbing is substantially smooth, enabling the strap to slide along the bark of the tree. Polymeric webbing also prevents fraying and torn straps to damage the tree as the webbing is typically sealed by a heat process to prevent the fraying and tearing from occurring. An example of one type of tree strap that may be used as a first strap is the tree strap sold by Jeffco Enterprises, Inc., located in Lakewood, Colo. Some first straps may have a separate cloth liner in the flat surface 17 of the strap to keep the tree from being damaged.

Generally, the material used for the first strap 12 may be any color material. However, it is desirable in many circumstances for the first strap to be a color other than white in order for the strap to generally blend in with the tree bark. For example, first straps often have colors such as green, tan, or black. Different shades and hues of these colors are often used, depending on the nature of the tree and the color of the bark, or other landscaping considerations.

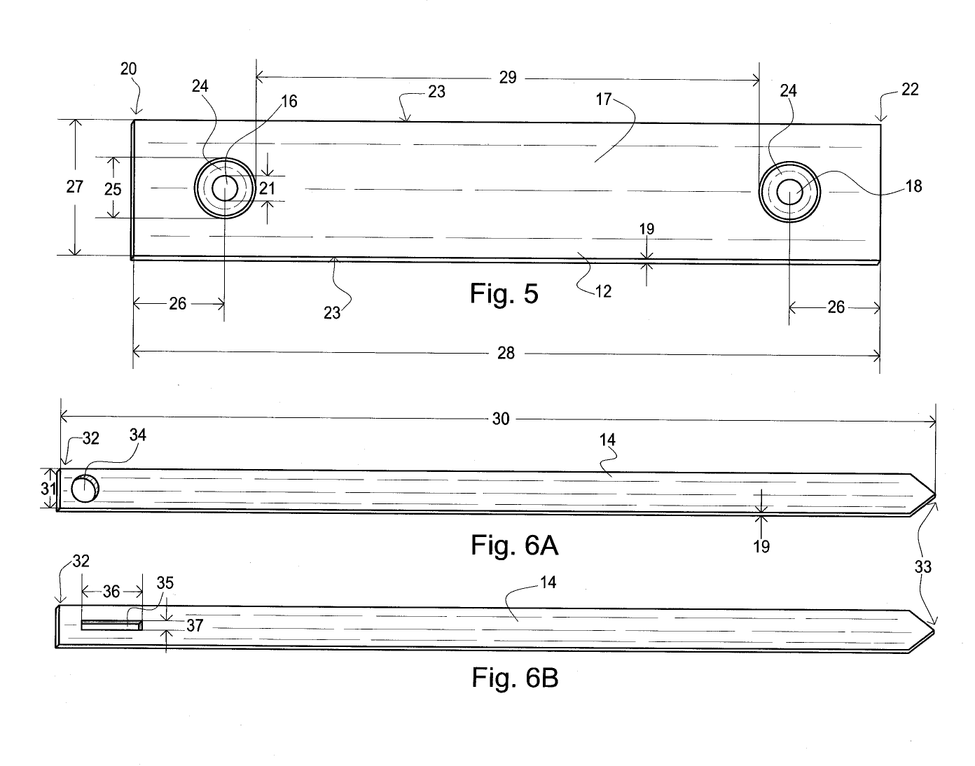

The first strap 12 in one embodiment is also comprised of a first bore 16 and a second bore 18. As best shown by FIG. 5, each bore is located proximate to an end of the first strap, with the first bore located proximate the proximal end 20 of the first strap and the second bore located proximate the distal end 22 of the first strap in one variation. Each bore may have a grommet 24, or eyelet, surrounding the bore. The grommets are used in variations to reinforce and strengthen the bores in the first strap.

The center of each first strap 12 bore in one embodiment is generally located an equal distance 26 from it's respective nearest first strap end. In one embodiment, the distance from the bore center to the nearest strap end is equal to ⅞ of an inch. Additionally, the distance each bore center is located from the edge of a strap edge 23 is generally equal, thereby widthwisely locating the first strap bores generally in the middle of the strap.

The size of the grommet, if used, should not be of a size which substantially hinders the flexibility of the strap. However, the grommet should be of a size which provides adequate protection to the bore. Generally, the outer diameter 25 of the grommet should be less than half the width 27 of the first strap, although some embodiments may exceed this general rule in certain circumstances. Likewise the thickness of the grommet, or the difference between the outer diameter and inner diameter 21, should not hinder the flexibility of the strap. The outer diameter 25 of the grommet is 11/16 of an inch and the inner diameter 21 of the grommet is 5/16 of an inch in one embodiment. In order for the grommet to operate and attach properly to the strap, the bore diameter in the first strap should be between these two lengths. The grommet and bore diameter sizes may differ for larger or smaller first and second strap lengths and widths. Grommets may be comprised of brass in one embodiment.

The first strap 12 dimensions are typically adapted to allow the strap to create a loop around the trunk of tree sapling and enable the longitudinal axis of the bores to substantially align. The first strap dimensions should also allow the strap to create a sufficient brace against the tree trunk, allow for easy set-up and should not cause undue damage to the tree surface or otherwise. For example, the width 27 of the first strap should be wide enough to provide support to the tree and to ensure that the strap does not dig into the bark or surface of the tree, but the width must not be so wide as to create a strap which is ungainly either in appearance, operation, or storage. One embodiment's first strap has a width of about 1½ inches. However, the width may be larger or smaller in some variations. For example, the width one larger embodiment is about 2 inches and in one smaller embodiment is about ¾ of an inch.

The length 28 of a first strap 12 in one embodiment is about 12 inches. However, embodiments are contemplated that have lengths of about 8, 15, or 18 inches. The smaller length first straps are usually used on smaller trees and tree saplings that have smaller trunk diameters. As best shown in FIG. 3, the first strap length is usually sized to allow the strap to wrap around the trunk of a tree to the point where the first strap bores are located to a side of the trunk of the tree which opposes the side of the tree that the center of the first strap is located proximate to. Therefore, the circumference of the tree is often not greater than the between-bore distance 29.

As best shown in FIG. 1, the second strap 14 is coupled to the first strap 12 in one embodiment with a grommet 24. Typically the second strap is coupled to the grommet encircling the second bore 18. Like the first strap, the second strap is generally rectangularly shaped. Also, the second strap is comprised of material similar to the first strap's material.

The length 30 of the second strap is typically longer than the length of the first strap in one variation, while the width 31 of the second strap is generally smaller than the width of the first strap. One embodiment has a second strap whose length is about 4 feet, although the second strap may have a length lesser or greater than 4 feet. Both a 3 foot and 10 foot length second strap have been contemplated, with the 10 foot length often being used for larger trees. Likewise, the width of the second strap in one 4 foot embodiment is about ¾ of an inch, but the width may be as small as ½ an inch or as great as 1 inch in other embodiments. In one variation, the first and second straps are coupled in a manner where the longitudinal axis of the two straps are generally parallel.

The color of the second strap 14 is typically different than the color of the first strap 12, with the-second strap being a generally bright color. In one embodiment, the color of the second strap is a light color such as, but not limited to, white. It is contemplated that the second strap may be other colors such as, but not limited to, neon green, yellow, or orange, or may have reflective qualities and attributes. In general, the color of the strap should be such that it stands out from the surroundings and is easily noticed by an approaching person.

As best shown by FIG. 1, in one embodiment, the outer diameter 25 of the grommet 24 may be generally equal to the width 31 of the second strap 14. As best shown by FIG. 6A, The second strap proximal end 32 has a second strap bore 34 located proximate the proximal end. The second strap is typically coupled to the first strap through the grommet 24 reinforcing the first strap's second bore 18. Therefore, the grommet also protects the second strap bore in substantially the same manner as the first strap bores are protected by each grommet, respectively.

The second strap 14 is typically coupled to the first strap 12 in a manner where the distal end 33 of the second strap stretches away from first strap proximal end 20 and the first strap distal end 22. Additionally, the first strap and second strap may not be coupled together, but may be integrated. The integrated strap may be a single unitary strap of varying width and color. The second strap 14 may also have a pointed distal end 33, as best shown in FIG. 6A. The distal end may be a generally pointed distal end in order for the distal end to easily allow the distal end to thread through the bores. As the second strap is threaded through the bores, the grommets help prevent the second strap from tearing through the material surrounding the bore, thereby providing structural integrity to the bore. Lastly, the second strap is adapted to easily couple to a device such as, but not limited to, as stake, the stake being adapted to be driven into the ground in order to keep the second strap taut.

The first strap 12 and the second strap 14 have generally equal thickness 19. One embodiment's strap thickness is 1/20 of an inch.

### Second Embodiment of a Tree Support Device

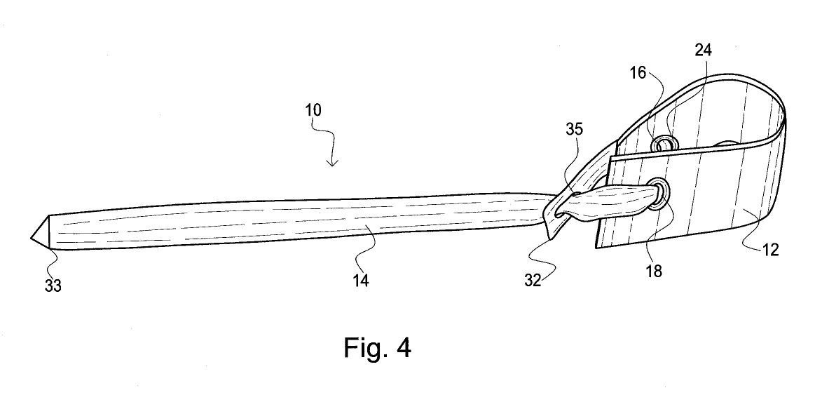

Referring to FIGS. 4 and 6B a second embodiment of a tree support device 10 is illustrated. The second embodiment is also similar to the first embodiment as shown FIGS. 3 and 5. The second embodiment is substantially similar to the first embodiment except the second strap bore 34 is replaced with a second strap slit 35, and the second strap couples to the first strap in a manner different than the first embodiment. In the second embodiment, the second strap is not initially coupled to the first strap 12 through a grommet 24.

As best shown by FIG. 6B, the second strap slit 35 is located proximate the proximal end 32 of the second strap. In the first embodiment, the second strap bore 34 was located proximate the proximal end. The slit 35 typically has a length 36 of about 1 inch and a width 37 of about 1/16 of an inch. However, in on variation, the slit is a generally circular grommeted slit similar to the first strap's second bore 18.

The slit 35 is adapted to enable the second strap 14 to couple to the first strap 12. To do so, as best shown in FIG. 4, upon the first strap creating a loop (such as, but not limited to, around a tree sapling trunk) and the longitudinal axis of the first strap bores are generally aligned, the proximal end 32 of the second strap is threaded through the first strap bores. Prior to the distal end 33 of the second strap threading through the first strap bores, the proximal end of the second strap is threaded through the slit 35. Doing so secures the first strap in a general loop shape around the ends of the first strap, thereby coupling the second strap to the first strap. Upon the second strap being pulled taut, the first strap provides lateral support to the tree in a manner similar to the first embodiment providing support to the tree. The distal end of the second strap is typically adapted to couple to a stake which is substantially fixed to the ground.

### First Method of Supporting a Tree

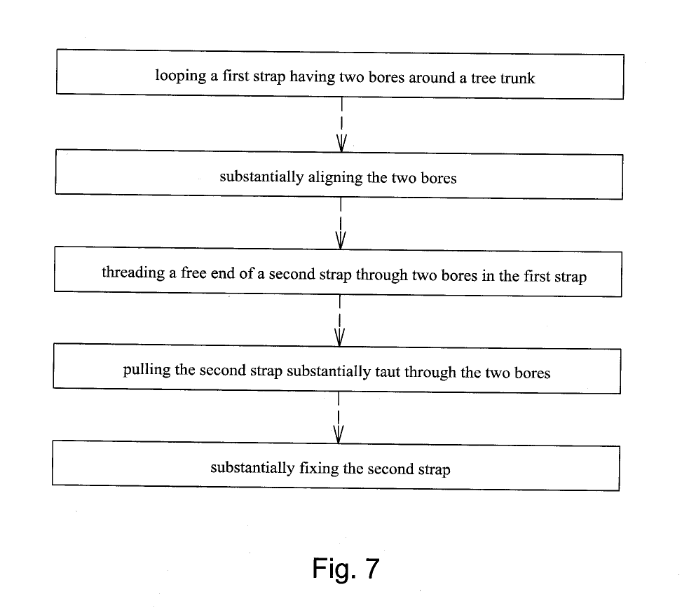

Referring to FIGS. 2, 3, 5, 6A, 6B and 7, a method of supporting a tree is illustrated. To begin, after a tree sapling is planted, a first strap 12 and second strap 14 are obtained. The first strap is substantially similar to the first embodiment first strap, with one method having a rectangular first strap including two bores. When a first strap is obtained, the strap is looped around the trunk of the tree sapling. The method may also be used to support items other than tree saplings, for example, small trees which are not tree saplings, plants, and structures that require support.

To place, or loop, the first strap 12, around a tree sapling, a portion of a flat surface 17 of the strap is placed flush with the tree trunk, with the proximal end 20 and distal end 22 of the first strap are wrapped around the trunk towards one another. The first strap should create a loop, as best shown in FIG. 2.

When the first strap 12 creates a loop around the trunk of the tree sapling, the first bore 16 and second bore 18 should generally align. The distal end 33 of the second strap 14, which is a free end of a second strap 14, is then threaded through the two bores. The second strap proximal end 32 may be initially coupled to the first strap distal end 22 by being coupled to a grommet 24 surrounding the first strap second bore, as previously disclosed in the first embodiment. In one method, upon looping the first strap around the tree, the second strap coupling to the first strap is located on the inside of the first strap loop around the tree. FIG. 2 shows the second strap threaded through the two first strap bores where the second strap coupling to the first strap is located on the outside of the first strap loop.

The second strap 14 may also be initially uncoupled to the first strap 12 through the grommet 24, as previously described in the second embodiment. When an initially uncoupled second strap is used, the second strap distal end 33 is threaded through a slit 35 in the second strap after first threading through the first strap bores, as best shown in FIG. 6B.

The second strap 14 is pulled taut through the two bores and the slit 35, if a slit is used. The second strap is then substantially fixed. Typically, as best shown in FIG. 3, the distal end 33 of the second strap is coupled to a stake or post. An end of the stake or post is then placed into the ground.

1) A tree support device comprising:
a first strap having a proximal end, a distal end, a first bore, and a second bore;
a second strap coupled to the first strap at the second bore, wherein a longitudinal axis of the first strap and a longitudinal axis of the second strap are generally parallel.

2) The tree support device of claim 1 wherein, the first bore is proximate the proximal end and the second bore is proximal the distal end.

3) The tree support device of claim 2 wherein, a grommet is coupled to the first bore and the second bore.

4) The tree support device of claim 3 wherein,
the first strap is wider than the second strap;
the first strap is shorter than the second strap; and
the grommet coupled to the second bore is also coupled to a second strap proximal end.

5) The tree support device of claim 4 wherein, the second strap is adapted to loop through the first bore and the second bore.

6) The tree support device of claim 1 wherein, at least one of the first strap or the second strap is comprised of polypropylene.

7) The tree support device of claim 1 wherein, the second strap is white.

8) The tree support device of claim 1 wherein,
the first strap length is about 8 inches to 18 inches;
the first strap width is about ¾ inches to 2 inches;
the second strap width is about ½ inch to 1 inch; and
the second strap length is about 3 feet to 10 feet.

9) A tree support device comprising:
a first strap having a first bore and a second bore;
a second strap having (i) at least one second strap bore, (ii) a distal end, (iii) a width less than a width of the first strap, and (iv) a length greater than a length of the first strap; and
wherein, the second strap is coupled to the first strap in a manner such that the at least one second strap bore is substantially aligned with at least one of the first bore and the second bore.

10) The tree support device of claim 9 wherein, a longitudinal axis of the first strap and a longitudinal axis of the second strap are substantially parallel.

11) The tree support device of claim 10 wherein, each of the first bore and the second bore have a diameter sufficient for the second strap to pass therethrough.

12) A combination comprising the tree support device of claim 10, a tree, and a stake, wherein,
the first strap is looped around the tree;
the second strap is passed through the first bore and the second bore and coupled to a stake; and
the stake is adapted to be driven into a ground.

13) The tree support device of claim 10 wherein,
at least one of the first and second looping straps are comprised of a flexible synthetic polymeric material; and
at least one of the first bore and the second bore is grommetted.

14) The tree support device of claim 11 wherein, the at least one bore is a generally rectangular bore.

15) The tree support device of claim 14 wherein,
the first strap is a polypropylene strap having a proximal end and a distal end,
the first bore having a grommet and being proximate to the proximal end and the second bore having a grommet and being proximate to the distal end;
the first strap width being about ¾ inches to 2 inches;
the first strap length being about 8 inches to 18 inches; and
the second strap is being a polypropylene white strap and having the distal end adapted to thread through the rectangular bore;
the second strap having a width from about ½ inch to 1 inch; and
the second strap having a length from about 3 feet to 10 feet.

16) A method of supporting a tree, the method comprising:
providing the tree support device of claim 1;
looping a first strap having a first bore and a second bore around a tree trunk;
substantially aligning the first bore and the second bore;
threading a free end of a second strap through the first bore and second bore;
pulling the second strap substantially taut through the two bores; and
substantially fixing the second strap.

17) The method of claim 16 further comprising,
planting a tree, wherein, the tree is a tree sapling.

18) The method of claim 17 further comprising,
driving a stake into the ground at a short distance from the tree.

19) The method of claim 18 wherein, substantially fixing the second strap includes coupling the second trap to the stake.

20) The method of claim 16 further including,
providing a second tree support device, including (i) a first strap having a first bore and a second bore, (ii) a second strap having at least one second strap bore, a distal end, a width less than a width of the first strap, and a length greater than a length of the first strap;
wherein, the second strap is coupled to the first strap in a manner where the at lest one second strap bore is substantially aligned with at least one of the first bore and the second bore;
pulling the second strap substantially taut through the first bore and second bore;
substantially fixing the second strap to a stake; and
driving the stake into the ground at point from the tree generally opposite the first tree support device.
